(19) United States
(12) Patent Application Publication
(10) Pub. No.: US 2012/0147899 A1
(43) Pub. Date: Jun. 14, 2012

(54) Media Access Control (MAC) Layer for Power Line Communications (PLC)

(75) Inventors: Shu Du, San Jose, CA (US); Xiaolin Lu, Plano, TX (US); Badri N. Varadarajan, Mountain View, CA (US)

(73) Assignee: TEXAS INSTRUMENTS INCORPORATED, Dallas, TX (US)

(21) Appl. No.: 13/300,850

(22) Filed: Nov. 21, 2011

Related U.S. Application Data
(60) Provisional application No. 61/422,441, filed on Dec. 13, 2010.

(51) Int. Cl. H04L 12/413

(52) U.S. Cl. 370/447

(57) ABSTRACT

Systems and methods for a media access control (MAC) layer for power line communications (PLC) are described. In some embodiments, a method may include receiving packets for transmission, each packet associated with a priority code, each priority code unrelated to its corresponding packet's time or order of arrival. The method may also include transmitting a first subset of packets having priority codes higher than priority codes in a second subset, and buffering the packets in the second subset for later transmission. Another method may include identifying a link quality indicator (LQI) associated neighboring service nodes, selecting one of the service nodes with highest LQI, and transmitting a promotion needed packet data unit to the selected service node. Yet another method may include communicating an Internet protocol (IP)-based message to a PLC device that excludes mesh header information, fragmentation header information, and/or the IP address of the PLC device.

### CROSS-REFERENCE TO RELATED APPLICATION(S)

This application claims the benefit of the filing date of U.S. Provisional Patent Application No. 61/422,441, which is titled “MAC Layer Improvement for PRIME” and was filed on Dec. 13, 2010, the disclosure of which is hereby incorporated by reference herein in its entirety.

### TECHNICAL FIELD

Embodiments are directed, in general, to power line communications (PLC), and, more specifically, to a media access control (MAC) layer for PLC.

### BACKGROUND

Power line communications (PLC) include systems for communicating data over the same medium (i.e., a wire or conductor) that is also used to transmit electric power to residences, buildings, and other premises. Once deployed, PLC systems may enable a wide array of applications, including, for example, automatic meter reading and load control (i.e., utility-type applications), automotive uses (e.g., charging electric cars), home automation (e.g., controlling appliances, lights, etc.), and computer networking (e.g., Internet access), to name a few.

Various PLC standardizing efforts are currently being undertaken around the world, each with its own unique characteristics. Generally speaking, PLC systems may be implemented differently depending upon local regulations, characteristics of local power grids, etc. Examples of competing PLC standards include the IEEE 1901, HomePlug AV, Powerline Intelligent Metering Evolution (PRIME), and the ITU-T G.hn (e.g., G.9960 and G.9961) specifications.

### SUMMARY

Systems and methods for a media access control (MAC) layer for power line communications (PLC) are described. In an illustrative embodiment, a method may include receiving a plurality of packets for transmission over a PLC network, each of the plurality of packets associated with a priority code, and each priority code unrelated to its corresponding packet's time or order of arrival at the PLC device. The method may also include performing a carrier sense multiple access (CSMA) operation, and, in response to the CSMA operation allowing transmission, transmitting a first subset of the plurality of packets. In some cases, priority codes associated with packets in the first subset may be higher than priority codes associated with packets in a second subset of the plurality of packets. The method may further include buffering the packets in the second subset for later transmission, for example, after a subsequent CSMA operation.

In some implementations, performing a CSMA operation may include performing a physical carrier sense (PCS) operation after a backoff time. Moreover, each priority code may be added to its corresponding packet by a respective packet-originating device, at least one of the packet-originating devices being distinct from the PLC device.

The method may also include increasing a priority code of a given packet in the second subset prior to the later transmission. For example, increasing the priority code may include increasing the priority code by an amount corresponding to a number of transmission opportunities missed by the given packet. Additionally or alternatively, increasing the priority code includes increasing the priority code by an amount corresponding to a time during which the given packet is buffered.

The method may further include re-transmitting the data packet in response to not having received an acknowledgement prior to expiration of a timeout. For example, the method may include increasing the priority code associated with the data packet prior to its re-transmission by an amount corresponding to at least one of: a number of transmission opportunities missed by the data packet or a time during which the data packet is buffered.

In another illustrative embodiment, a method may include identifying a link quality indicator (LQI) associated with each of a plurality of service nodes neighboring the PLC device in a PLC network, selecting one of the plurality of service nodes with highest LQI, and transmitting a promotion needed packet data unit (PNPDU) to the selected service node to the exclusion of the other service nodes. In some cases, the selected service node may be configured to send a promotion request to a base node after the expiration of a randomly selected time interval.

Additionally or alternatively, the base node may be configured to maintain a keep-alive table for each node in the PLC network, and the selected service node does not maintain a keep-alive timer associated with the base node. The method may also include receiving a beacon packet from the selected service node and designating the selected service node as being alive in response to having received the beacon without having received a keep-alive message from the selected service node.

In yet other embodiments, a method may include transmitting a first Internet protocol (IP) -based message to another PLC device over a PLC network, the first IP-based message excluding at least one of: mesh header information, fragmentation header information, or IP address of the other PLC device. The method may further include receiving a second IP-based message from the other PLC device in response to the first message over the PLC network, the second IP-based message also excluding at least one of: mesh header information, fragmentation header information, or IP address of the PLC device.

In various implementations, one or more of the methods described herein may be performed by one or more PLC devices (e.g., a PLC meter, PLC data concentrator, etc.). In other implementations, a tangible electronic storage medium may have program instructions stored thereon that, upon execution by a processor within one or more PLC devices, cause the one or more PLC devices to perform one or more operations disclosed herein. Examples of such a processor include, but are not limited to, a digital signal processor (DSP), an application specific integrated circuit (ASIC), a system-on-chip (SoC) circuit, a field-programmable gate array (FPGA), a microprocessor, or a microcontroller. In yet other implementations, a PLC device may include at least one processor and a memory coupled to the at least one processor, the memory configured to store program instructions executable by the at least one processor to cause the PLC device to perform one or more operations disclosed herein.

### BRIEF DESCRIPTION OF THE DRAWINGS

Reference will now be made to the accompanying drawings, wherein:

FIG. 1 is a diagram of a PLC system according to some embodiments.

FIG. 2 is a block diagram of a PLC device or modem according to some embodiments.

FIG. 3 is a block diagram of a PLC gateway according to some embodiments.

FIG. 4 is a block diagram of a PLC data concentrator according to some embodiments.

FIG. 5 is a diagram of a portion of a PLC protocol stack according to some embodiments.

FIG. 6 is a diagram of a PLC mesh network according to some embodiments.

FIG. 7 is a flowchart of a PLC bootstrapping procedure according to some embodiments.

FIG. 8 is a flowchart of a PLC transmission control procedure according to some embodiments.

FIG. 9 is a flowchart of a PLC automatic repeat request (ARQ) procedure for data packets according to some embodiments.

FIG. 10 is a block diagram of an integrated circuit according to some embodiments.

### DETAILED DESCRIPTION

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s) to a person of ordinary skill in the art. A person of ordinary skill in the art may be able to use the various embodiments of the invention(s).

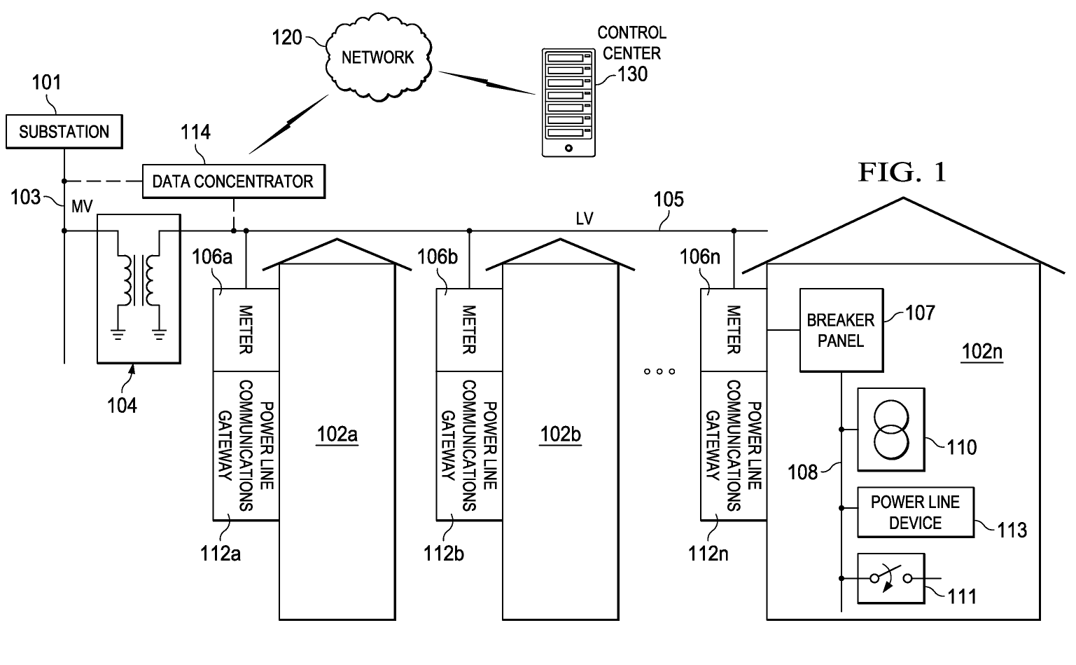

Turning to FIG. 1, a power line communication (PLC) system is depicted according to some embodiments. Medium voltage (MV) power lines 103 from substation 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters 106a-n, which are typically mounted on the outside of residences 102a-n. (Although referred to as “residences,” premises 102a-n may include any type of building, facility or location where electric power is received and/or consumed.) A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use a carrier signal having a frequency different from that of the power signal. The carrier signal may be modulated by the data, for example, using an orthogonal frequency division multiplexing (OFDM) scheme or the like.

PLC modems or gateways 112a-n at residences 102a-n use the MV/LV power grid to carry data signals to and from PLC data concentrator or router 114 without requiring additional wiring. Concentrator 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more PLC data concentrators or routers 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

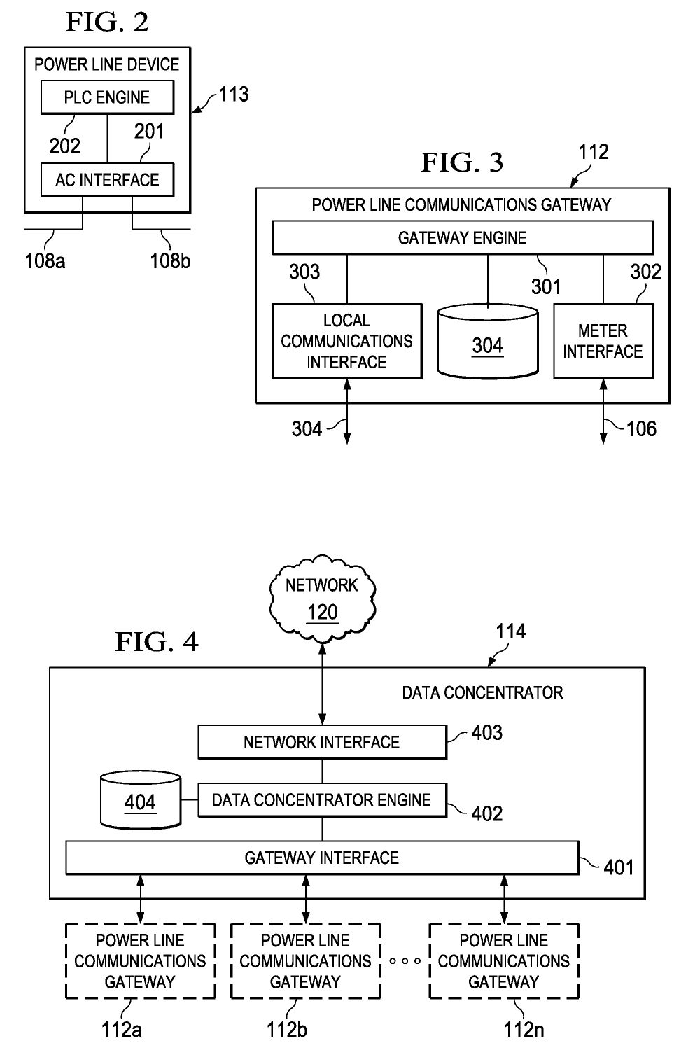

FIG. 2 is a block diagram of PLC device 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. In some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data aggregators 114, etc.) for further processing. Conversely, PLC engine 202 may receive instructions and/or other information from such higher-level PLC devices encoded in PLC signals, for example, to allow PLC engine 202 to select a particular frequency band in which to operate.

FIG. 3 is a block diagram of PLC gateway 112 according to some embodiments. As illustrated in this example, gateway engine 301 is coupled to meter interface 302, local communication interface 304, and frequency band usage database 304. Meter interface 302 is coupled to meter 106, and local communication interface 304 is coupled to one or more of a variety of PLC devices such as, for example, PLC device 113. Local communication interface 304 may provide a variety of communication protocols such as, for example, ZIGBEE, BLUETOOTH, WI-FI, WI-MAX, ETHERNET, etc., which may enable gateway 112 to communicate with a wide variety of different devices and appliances. In operation, gateway engine 301 may be configured to collect communications from PLC device 113 and/or other devices, as well as meter 106, and serve as an interface between these various devices and PLC data concentrator 114. Gateway engine 301 may also be configured to allocate frequency bands to specific devices and/or to provide information to such devices that enable them to self-assign their own operating frequencies.

In some embodiments, PLC gateway 112 may be disposed within or near premises 102n and serve as a gateway to all PLC communications to and/or from premises 102n. In other embodiments, however, PLC gateway 112 may be absent and PLC devices 113 (as well as meter 106n and/or other appliances) may communicate directly with PLC data concentrator 114. When PLC gateway 112 is present, it may include database 304 with records of frequency bands currently used, for example, by various PLC devices 113 within premises 102n. An example of such a record may include, for instance, device identification information (e.g., serial number, device ID, etc.), application profile, device class, and/or currently allocated frequency band. As such, gateway engine 301 may use database 304 in assigning, allocating, or otherwise managing frequency bands assigned to its various PLC devices.

FIG. 4 is a block diagram of PLC data concentrator or router 114 according to some embodiments. Gateway interface 401 is coupled to data concentrator engine 402 and may be configured to communicate with one or more PLC gateways 112a-n. Network interface 403 is also coupled to data concentrator engine 402 and may be configured to communicate with network 120. In operation, data concentrator engine 402 may be used to collect information and data from multiple gateways 112a-n before forwarding the data to control center 130. In cases where PLC gateways 112a-n are absent, gateway interface 401 may be replaced with a meter and/or device interface (now shown) configured to communicate directly with meters 116a-n, PLC devices 113, and/or other appliances. Further, if PLC gateways 112a-n are absent, frequency usage database 404 may be configured to store records similar to those described above with respect to database 304.

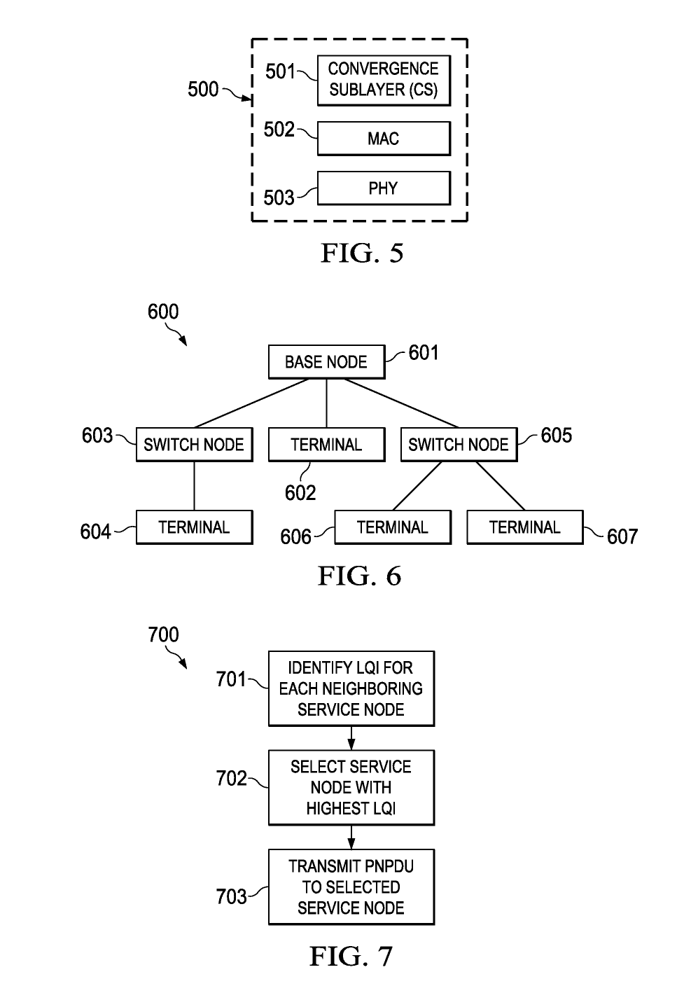

For ease of explanation, some of system and/or techniques presented herein are discussed in the context of the Powerline Intelligent Metering Evolution (PRIME) standard, and may be particularly well suited for increasing the stability and/or scalability of networks based on that standard. In other embodiments, however, similar systems and/or techniques may be adapted for operation under other PLC standards. FIG. 5 is a diagram of a portion of a PLC protocol stack as defined by the PRIME standard with a new and/or modified media control access (MAC) layer according to some embodiments. This example is based on the IEEE 802.16 protocol layering. In particular, control and data plane 500 includes convergence sublayer (CS) 501, MAC layer 502, and physical layer (PHY) 503.

Service-specific CS layer 501 is configured to classify traffic associating it with its proper MAC connection. As such, CS layer 501 may be able to perform a mapping of different kinds of traffic to be properly included in MAC protocol data units (PDUs). For example, in some embodiments, CS layer 501 may support the Internet Protocol (IP) version 6 (IPv6), IPv4, IEC-61334, or the like. CS layer 501 may also include payload header suppression or other capabilities. In some cases, two or more CS layers may be used to accommodate different types of traffic. MAC layer 502 may provide core MAC capabilities of system access, bandwidth allocation, connection management, topology resolution, etc., and several of its aspects are discussed in detail below with respect to FIGS. 6-9. Meanwhile, PHY layer 503 may be configured to transmit and receive MAC PDUs between PLC devices or nodes.

FIG. 6 is a diagram of a PLC mesh network according to some embodiments. In various implementations, the PLC devices employed in network 600 may be configured to communicate with each other using the PLC protocol stack described in FIG. 5. As shown, base node 601 is configured to communicate with terminal node 602 and with switch nodes 603 and 605. Switch node 603 is configured to communicate with terminal node 604, and switch node 605 is configured to communicate with terminal nodes 606 and 607. In practice, base node 601 may be implemented, for example, by a PLC data concentrator or router (e.g., 114). On the other hand, terminal and switch nodes 602-607 may be implemented by any PLC device (e.g., 106 and/or 110-113) shown in FIG. 1.

Base node 601 is at the root of network 600 and acts as master node that provides connectivity to other devices. When the network is first being formed, each of nodes 602-607 (referred to as “service nodes”) follows a “bootstrapping” procedure for registering with base node 601. Service nodes 602-607 are either leafs of the tree or branch points of the network tree. Depending upon its position, a service node may be in charge of connecting itself to network 600 and switching the data of its neighboring node(s) in order to propagate connectivity. As shown in FIG. 6, service nodes 604, 606, and 607 are operating in terminal mode, and service nodes 603 and 605 are operating in switch mode. As such, switch node 603 is responsible for forwarding traffic between base node 601 and terminal 604 (in addition to its own traffic), whereas switch node 605 does the same for terminals 606 and 607. During operation, a service node may change its behavior dynamically from terminal to switch modes depending upon the network topology and/or traffic conditions.

A typical procedure for routing messages in a network such as network 600 may include using an Ad hoc On Demand Distance Vector (AODV) routing algorithm or the like. Particularly, a booting node without direct access to base node 601 (e.g., service node 606) may broadcast a promotion needed packet data unit (PNPDU) request to other service nodes (e.g., service nodes 602 and 605). Each service node that receives a PNPDU may in turn transmit a promotion request (PRO) to base node 601. Base node 601 then determines which of the service nodes should be promoted to switch mode in order to facilitate communications between it the booting node (in this case, node 605 was promoted to switch and 602 was not). However, as the inventors hereof have recognized, these conventional protocols have a number of shortcomings. For example, a booting node does not have the choice about which switch node to select. In many cases, is possible that a node with a bad link to the booting node gets promoted. Also, there may be many nodes' requests for promotion for the same booting node, thus creating congestion in the network.

To address these and other issues, FIG. 7 is a flowchart of a PLC bootstrapping procedure according to some embodiments. Method 700 may be performed by a booting node such as, for example, any booting node or PLC device (e.g., 106 and/or 110-113) represented as a service node 602-607 in FIG. 6. At block 701, a PLC device may identify a link quality indicator (LQI) associated with each of a plurality of service nodes neighboring the PLC device in the PLC network. At block 702, the PLC device may select one of the plurality of service nodes with highest LQI. At block 703, the PLC device may transmit a PNPDU to the selected service node to the exclusion of the other service nodes.

In some cases, at block 701, the PLC device or booting node may receive a beacon packet or other control information from neighboring service nodes with LQI information. In other cases, at block 701, the PLC device or booting node may broadcast a control message (or other message), receive a response from the plurality of neighboring service nodes, calculate a signal-to-noise ratio (SNR) value for each such node, and use the calculated SNR value as a LQI indicator. Additionally or alternatively, in some cases, the PLC device or booting node may receive two or more beacon packets, control messages, or other messages from a same service node, and combine or average identified (or calculated) LQIs to arrive at an averaged LQI for that service node; which may then be compared to similarly averaged LQIs for other service nodes at block 702.

In some embodiments, the selected service node may be configured to send a promotion request (PRO) to a base node after the expiration of a randomly selected time interval to avoid PRO burst. As such, when a new node tries to join a network, it can potentially pinpoint the one with the best LQI to be promoted to switch, and the new node's neighbors are less likely to rush to send PRO packets to the base node.

Referring back to FIG. 6, once nodes have joined network 600, each of switch nodes 603 and 605 would ordinarily track the keep-alive of terminals 604, 606, and 607, which is an extra burden for the switch nodes. Further, base node 601 would ordinarily poll the keep-alive in a burst, causing response keep-alive to collide with each other. As such, traditional keep-alive procedures may become a burden when the network scales to thousands of nodes.

To address these and other issues, in some embodiments, base node 601 may be configured to maintain a keep-alive table for each of nodes 602-607, and therefore nodes 602-607 need not maintain a keep-alive timer and/or table associated with base node 601. For example, terminal 606 may receive a beacon packet from switch node 605 (its selected service node), and designate switch node 605 as being alive in response to simply having received the beacon, and without having had to receive a specifically designed keep-alive message or response from the selected service node. In some implementations, when a first service node receives a packet from a second service node, the first service node may start a keep-alive timer for the second service node. If the first service node receives another packet from the second service node prior to the expiration of a selected time interval, the keep-alive timer may be reset. If the time interval expires prior to receipt of another packet from the second service node, the first service node may transmit a keep-alive request to the second service node and/or may declare the second service node unreachable, in which case it may repeat the bootstrapping procedure.

As such, switch nodes need not track a keep alive timeout for its terminals. Keep-alive timers are only maintained at the base node, and service nodes only respond to the base node's keep-alive request. Also, a service node does not need to maintain a keep-alive timer for the base node. Service node may monitor the beacons from the parent switch node at all times, which is a good indication of that the network is alive. Moreover, the keep-alive procedure may have a non-fixed interval mode. In this mode, as long as a base node can get any packet, such as meter reading, from a service node, it can assume the other side is alive and does not need to send a keep-alive request message. Accordingly, in some embodiments, the keep-alive procedure may serve a purpose similar to the “ping” operation in IPv4; that is, an given node may ping another node to understand if it is still alive, and may also determine the round trip time or other path information.

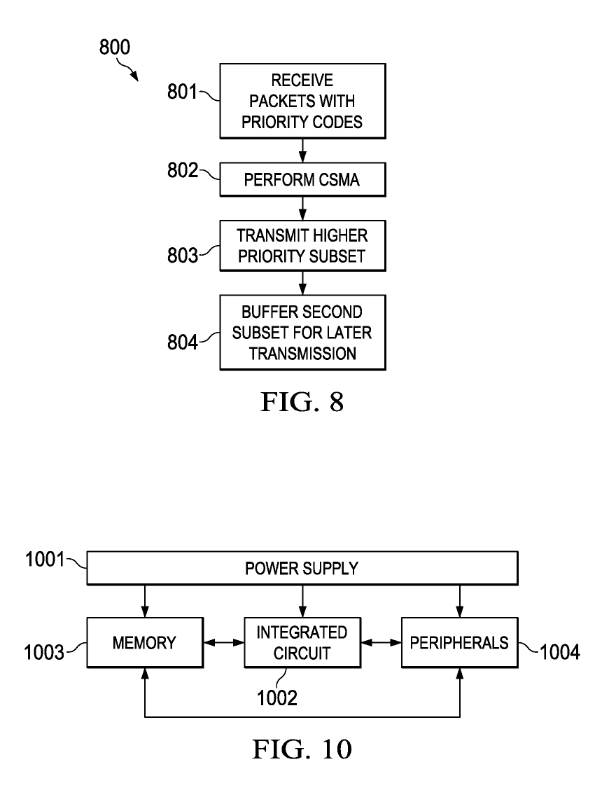

During operation of network 600, the various service nodes 602-607 may communicate with base node 601 and/or with each other following a transmission or access control procedure. FIG. 8 is a flowchart of a PLC transmission control procedure. In various embodiments, method 800 may be performed by any of service nodes 602-607. At block 801, a service node (e.g., switch node 605) may receive a plurality of packets for transmission over a PLC network, each of the plurality of packets associated with a priority code, each priority code unrelated to its corresponding packet's time or order of arrival at the service node. For example, each priority code may be added to its corresponding packet by a respective packet-originating device, the packet-originating device (e.g., terminal 606) being distinct from the service node.

At block 802, the service node may perform a carrier sense multiple access (CSMA) operation. For example, performing the CSMA operation may include performing a physical carrier sense (PCS) operation after a backoff time. At block 803, the service node may transmit a first subset of the plurality of packets, where priority codes associated with packets in the first subset are higher than priority codes associated with packets in a second subset of the plurality of packets. At block 804, the service node may buffer the packets in the second subset for later transmission, for example, after a subsequent CSMA operation.

To illustrate the foregoing, consider the following hypothetical. In this scenario, switch node 605 receives a first packet from terminal 606 to be transmitted to base node 601, and the first packet includes a priority code “3” (e.g., on a scale from 0 to 3, where 0 indicates the highest priority and 3 indicates the lowest priority). Assume that the medium and/or frequency allocated for communications between switch node 605 and base node 601 is busy, and therefore the first packet cannot be immediately relayed to base node 601. Then a second packet (e.g., originated by one of terminals 606 or 607) arrives at switch node 605, but with a priority code “0.” Also assume that, once switch node 605 senses that the medium is free (e.g., via a CSMA mechanism or the like), it determines that it can only send one packet to base node 601 (e.g., because the duration of the frame is not sufficient to send both packets). Conventional techniques would require that the first packet be transmitted prior to the second packet because it arrived at switch node 605 first. In contrast, in some embodiments, the second packet may be transmitted first because it has a higher priority than the first packet. The first packet may then be buffered in switch node 605 until the next transmission opportunity.

In some cases, the service node may increase the priority code of a given packet in the second subset prior to the later transmission. For example, the service node may increase the priority code by an amount corresponding to a number of transmission opportunities missed by the given packet. Additionally or alternatively, the service node may increase the priority code includes increasing the priority code by an amount corresponding to a time during which the given packet is buffered. As such, returning to the hypothetical scenario discussed above, the first packet may have its priority code increased (e.g., from 2 to 3 or another suitable amount) prior to the next transmission opportunity. The increased value may depend, for example, upon the number of missed opportunities and/or the time that the first packet has been held at switch node 605.

It should be understood that the preceding hypothetical is presented only for sake of explanation and not by way of limitation. In practical implementations, a switch node may receive a plurality of packets of varying priority from a variety of sources, and the switch node may also generate its own packets to be transmitted. The priority may be expressed as a code, indicator, or the like. Such a code may be binary (e.g., a packet is either high or low importance) or on a sliding scale. In some implementations, a larger value may indicate higher priority (e.g., “0” represents the lowest priority); in others a lower value may indicate the higher priority (e.g., “0” represents the highest priority).

The switch node may aggregate groups of packets by order of priority before the CSMA operation. If a first CSMA operation fails (i.e., the medium is busy), the aggregated groups may be broken down into individual packets and re-assembled prior to a subsequent CSMA operation. High priority data may be aggregated before low priority data, unless the current frame does not have enough duration left to transmit the high priority data but has sufficient duration for the low priority data. In some cases, the priority code may be embedded in the packet header by the originating device. In other cases, a priority code may be associated to a given packet by the switch node as a function of the originating device, traffic patterns detected by the switch node, under control of its base node, etc.

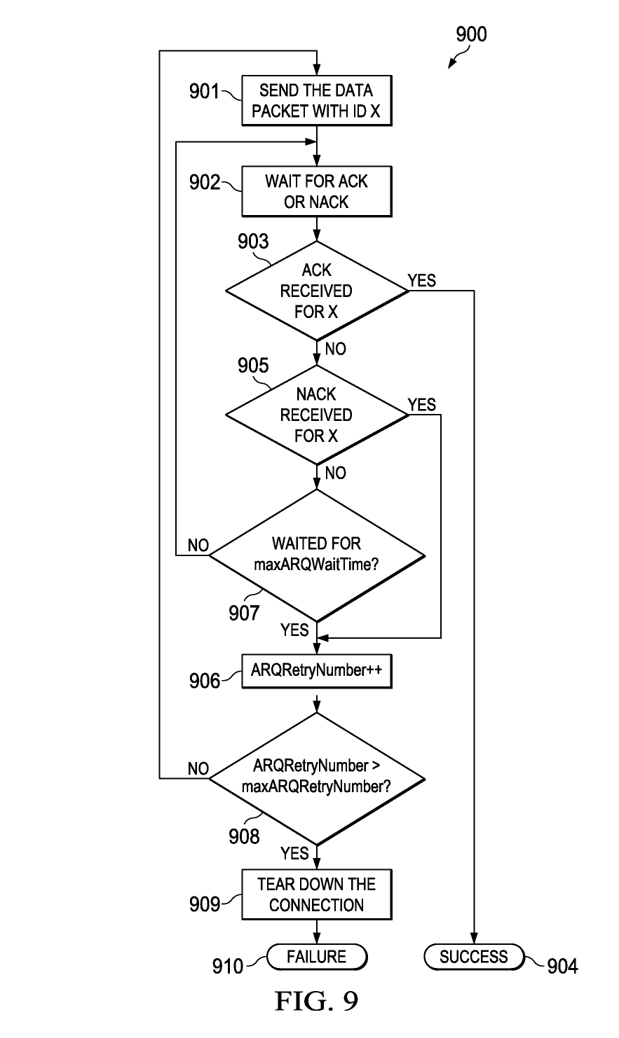

In various embodiments, after a packet is transmitted, an automatic repeat request (ARQ) may be implemented. Particularly with respect to the PRIME standard, the inventors hereof have recognized that ARQ-type features are only implemented with respect to control packets, and not for data packets. Hence, FIG. 9 is a flowchart of an ARQ procedure for data packets. In some embodiments, method 900 may be performed by any of service nodes 602-607 shown in FIG. 6. At block 901, a service node may transmit a data, non-control packet with ID “X.” At block 902, the service node may wait for an acknowledgement message (ACK or NACK) to be received in response to the data packet transmission. At block 903, if an ACK message is received, control passes to block 904, where a successful transmission of packet “X” is indicated. Otherwise control passes to block 905, where the service node determines whether a NACK message is received. If so, control passes to block 906. If not, control passes to block 907. At block 907 the service node determines whether a maximum ARQ wait time has been reached. If not, control returns to block 902. Otherwise, control passes to block 906.

At block 906, a retry counter representing the number of ARQ attempts is incremented. At block 908, if the counter is not greater than a maximum number of ARQ retries, control returns to block 902. Otherwise, at block 909, the service node may tear down the connection, and, at block 910, the service node may indicate a transmission failure for packet “X.” As such, in some embodiments, an ARQ timeout may be added for every packet, including non-control packets. A sender therefore does not need to wait indefinitely if ACK or NACK information does not arrive. Also, a maximum retry limit may be used. Thus, the sender does not need to retry the same transmission indefinitely if it receives NACK information or the maximum number of retries has been reached.

In some embodiments, if the ARQ method of FIG. 9 determines that packet “X” has not been successfully transmitted, the same packet may be retransmitted at a later time. In some cases, a priority code associated with a packet may be increased prior to its re-transmission by an amount corresponding to at least one of: a number of transmission opportunities missed by the data packet or a time during which the data packet is buffered.

Each packet transmitted within the PLC network may be defined by a given frame structure including for example, a number of time slots, a shared contention period (SCP), and a contention free period (CFP). When the frame structure changes during operation, a frame update (FRA) packet may be broadcast across the network (e.g., by a base node). Further, because the FRA packet is broadcast, it ordinarily does not receive a confirmation response from receiving service nodes. In some embodiments, rather than employing dedicated FRA packets, certain systems and methods described herein may rely upon switch nodes (e.g., 603 or 605) to send the new frame structure in the form of a beacon packet. When a switch node hears the new structure from its parent node, it may change its own packets' structure automatically. And because beacon packets are repeated periodically, new frame structures may propagate across the whole network and ultimately converge.

Still with respect to packet and frame structure, CS layer 501 shown in FIG. 5 may implement the IPv6 protocol. In some of the embodiments described herein, CS layer 501 may implement the IPv6 protocol without mesh header formation, as all MAC frames are known either to or from a base node. Similarly, fragmentation header formation may also be unnecessary, as segmentation and reassembly (SAR) service is configured to handle fragmentation. Also in some cases, in-network IDs (e.g., assigned by the base node) may be used to derive IPv6 source/destination addresses, and therefore IPv6 may be implemented with stateless address configurations—e.g., a node may join the network and setup its own IPv6 address based on a 1 on 1 mapping rule from network ID to IPv6 addresses. Moreover, in some embodiments, service nodes may take the base node as the network's default gateway, unlike other IPv6 implementations in other types of networks.

Accordingly, in some embodiments, a first service node may transmit a first Internet protocol (IP)-based message to a second service node, the first IP-based message excluding at least one of: mesh header information, fragmentation header information, or IP address of the second service node. Also, the first service node may receive a second IP-based message from the second service node in response to the first message, the second IP-based message excluding at least one of: mesh header information, fragmentation header information, or IP address of the first service node.

FIG. 10 is a block diagram of an integrated circuit according to some embodiments. In some cases, one or more of the devices and/or apparatuses shown in FIGS. 1-4 may be implemented as shown in FIG. 10. In some embodiments, integrated circuit 1002 may be a digital signal processor (DSP), an application specific integrated circuit (ASIC), a system-on-chip (SoC) circuit, a field-programmable gate array (FPGA), a microprocessor, a microcontroller, or the like. Integrated circuit 1002 is coupled to one or more peripherals 1004 and external memory 1003. In some cases, external memory 1003 may be used to store and/or maintain databases 304 and/or 404 shown in FIGS. 3 and 4. Further, integrated circuit 1002 may include a driver for communicating signals to external memory 1003 and another driver for communicating signals to peripherals 1004. Power supply 1001 is also provided which supplies the supply voltages to integrated circuit 1002 as well as one or more supply voltages to memory 1003 and/or peripherals 1004. In some embodiments, more than one instance of integrated circuit 1002 may be included (and more than one external memory 1003 may be included as well).

Peripherals 1004 may include any desired circuitry, depending on the type of PLC system. For example, in an embodiment, peripherals 1004 may implement local communication interface 303 and include devices for various types of wireless communication, such as WI-FI, ZIGBEE, BLUETOOTH, cellular, global positioning system, etc. Peripherals 1004 may also include additional storage, including RAM storage, solid-state storage, or disk storage. In some cases, peripherals 1004 may include user interface devices such as a display screen, including touch display screens or multi-touch display screens, keyboard or other input devices, microphones, speakers, etc.

External memory 1003 may include any type of memory. For example, external memory 1003 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, DRAM, etc. External memory 1003 may include one or more memory modules to which the memory devices are mounted, such as single inline memory modules (SIMMs), dual inline memory modules (DIMMs), etc.

It will be understood that various operations discussed with respect to FIGS. 1-9 may be executed simultaneously and/or sequentially. It will be further understood that each operation may be performed in any order and may be performed once or repetitiously. In various embodiments, the modules shown in FIGS. 2-4 may represent sets of software routines, logic functions, and/or data structures that are configured to perform specified operations. Although these modules are shown as distinct logical blocks, in other embodiments at least some of the operations performed by these modules may be combined in to fewer blocks. Conversely, any given one of the modules shown in FIGS. 2-4 may be implemented such that its operations are divided among two or more logical blocks. Moreover, although shown with a particular configuration, in other embodiments these various modules may be rearranged in other suitable ways.

Many of the operations described herein may be implemented in hardware, software, and/or firmware, and/or any combination thereof. When implemented in software, code segments perform the necessary tasks or operations. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc.

Software code segments may be stored in any volatile or non-volatile storage device, such as a hard drive, flash memory, solid state memory, optical disk, CD, DVD, computer program product, or other memory device, that provides tangible computer-readable or machine-readable storage for a processor or a middleware container service. In other embodiments, the memory may be a virtualization of several physical storage devices, wherein the physical storage devices are of the same or different kinds. The code segments may be downloaded or transferred from storage to a processor or container via an internal bus, another computer network, such as the Internet or an intranet, or via other wired or wireless networks.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

1. A method comprising:
performing, by a power line communication (PLC) device,
receiving a plurality of packets for transmission over a PLC network, each of the plurality of packets associated with a priority code, each priority code unrelated to its corresponding packet's time or order of arrival at the PLC device;
performing a carrier sense multiple access (CSMA) operation;
in response to the CSMA operation allowing transmission, transmitting a first subset of the plurality of packets, wherein priority codes associated with packets in the first subset are higher than priority codes associated with packets in a second subset of the plurality of packets; and
buffering the packets in the second subset for later transmission after a subsequent CSMA operation.

2. The method of claim 1, wherein performing the CSMA operation includes performing a physical carrier sense (PCS) operation after a backoff time.

3. The method of claim 1, wherein each priority code is added to its corresponding packet by a respective packet-originating device, at least one of the packet-originating devices being distinct from the PLC device.

4. The method of claim 1, further comprising:
performing, by the PLC device,
increasing a priority code of a given packet in the second subset prior to the later transmission.

5. The method of claim 4, wherein increasing the priority code includes increasing the priority code by an amount corresponding to a number of transmission opportunities missed by the given packet.

6. The method of claim 4, wherein increasing the priority code includes increasing the priority code by an amount corresponding to a time during which the given packet is buffered.

7. The method of claim 1, wherein the plurality of packets includes a data packet and a control packet, the method further comprising:
performing, by the PLC device,
re-transmitting the data packet in response to not having received an acknowledgement prior to expiration of a timeout.

8. The method of claim 7, further comprising:
performing, by the PLC device,
increasing a priority code associated with the data packet prior to its re-transmission, wherein increasing the priority code includes increasing the priority code by an amount corresponding to at least one of: a number of transmission opportunities missed by the data packet or a time during which the data packet is buffered.

9. The method of claim 1, wherein each of the plurality of packets includes an IP-based message, the IP-based message excluding at least one of: mesh header information, fragmentation header information, or IP address.

10. The method of claim 1, further comprising, prior to receiving the plurality of packets:
performing, by the PLC device,
identifying a link quality indicator (LQI) associated with each of a plurality of service nodes neighboring the PLC device in the PLC network;
selecting one of the plurality of service nodes with highest LQI; and
transmitting a promotion needed packet data unit (PNPDU) to the selected service node to the exclusion of the other service nodes.

11. A power line communication (PLC) device comprising:
a processor; and
a memory coupled to the processor, the memory configured to store program instructions executable by the processor to cause the PLC device to:
identify a link quality indicator (LQI) associated with each of a plurality of service nodes neighboring the PLC device in a PLC network;
select one of the plurality of service nodes with highest LQI; and
transmit a promotion needed packet data unit (PNPDU) to the selected service node to the exclusion of the other service nodes.

12. The PLC device of claim 11, wherein the processor includes a digital signal processor (DSP), an application specific integrated circuit (ASIC), a system-on-chip (SoC) circuit, a field-programmable gate array (FPGA), a microprocessor, or a microcontroller.

13. The PLC device of claim 11, wherein the selected service node is configured to send a promotion request to a base node after the expiration of a randomly selected time interval.

14. The PLC device of claim 13, wherein the base node is configured to maintain a keep-alive table for each node in the PLC network, and wherein the selected service node does not maintain a keep-alive timer associated with the base node.

15. The PLC device of claim 11, the program instructions further executable by the processor to cause the PLC device to:
receive a beacon packet from the selected service node; and
designate the selected service node as being alive in response to having received the beacon and without having received a keep-alive message from the selected service node.

16. The PLC device of claim 10, the program instructions further executable by the processor to cause the PLC device to:
receive a plurality of packets for transmission over a PLC network, each of the plurality of packets associated with a priority code, each priority code unrelated to its corresponding packet's time or order of arrival at the PLC device;
perform a carrier sense multiple access (CSMA) operation;
in response to the CSMA operation allowing transmission, transmit a first subset of the plurality of packets, wherein priority codes associated with packets in the first subset are higher than priority codes associated with packets in a second subset of the plurality of packets; and
buffer the packets in the second subset for later transmission after a subsequent CSMA operation.

17. The PLC device of claim 16, wherein each of the plurality of packets includes an IP-based message, the IP-based message excluding at least one of: mesh header information, fragmentation header information, or IP address.

18. A tangible electronic storage medium having program instructions stored thereon that, upon execution by a processor within a power line communication (PLC) device, cause the PLC device to:
transmit a first Internet protocol (IP) -based message to another PLC device over a PLC network, the first IP-based message excluding at least one of: mesh header information, fragmentation header information, or IP address of the other PLC device; and
receive a second IP-based message from the other PLC device in response to the first message over the PLC network, the second IP-based message excluding at least one of: mesh header information, fragmentation header information, or IP address of the PLC device.

19. The tangible electronic storage medium of claim 18, wherein the program instructions, upon execution by the processor, further cause the PLC device to:
identify a link quality indicator (LQI) associated with each of a plurality of service nodes neighboring the PLC device in a PLC network;
select one of the plurality of service nodes with highest LQI; and
transmit a promotion needed packet data unit (PNPDU) to the selected service node to the exclusion of the other service nodes.

20. The tangible electronic storage medium of claim 18, wherein the program instructions, upon execution by the processor, further cause the PLC device to:
receive a plurality of packets for transmission over a PLC network, each of the plurality of packets associated with a priority code, each priority code unrelated to its corresponding packet's time or order of arrival at the PLC device;
perform a carrier sense multiple access (CSMA) operation;
in response to the CSMA operation allowing transmission, transmit a first subset of the plurality of packets, wherein priority codes associated with packets in the first subset are higher than priority codes associated with packets in a second subset of the plurality of packets; and
buffer the packets in the second subset for later transmission after a subsequent CSMA operation.
